(19) United States
(12) Patent Application Publication
(10) Pub. No.: US 2016/0073817 A1
(43) Pub. Date: Mar. 17, 2016

(54) BREWING CUP INSTRUMENT AND ITS OPERATING METHOD

(71) Applicant: Yi-Pin Tseng, Taipei City (TW)

(72) Inventor: Yi-Pin Tseng, Taipei City (TW)

(21) Appl. No.: 14/766,978

(22) PCT Filed: Dec. 10, 2013
(86) PCT No.: PCT/CN2013/089008

§ 371 Date: Aug. 10, 2015

(30) Foreign Application Priority Data
Dec. 10, 2012 (CN) 201210530659.9

(51) Int. Cl. A47J 31/06

(52) U.S. Cl. CPC A47J 31/0636

(57) ABSTRACT

A brewing cup instrument, and its operating method. A brewing cup instrument includes a cup, a lid and a depressible brewing substance packaging. A hole pass through the lid, and a position part at the outside edge of the lid. A brewing substance packaging includes a rope body, a covered body, and a positioning body. When the positioning body is located in the brewing position, it is driven by the gravity of the covered body, and stopped by the lid, so that the covered body is hung inside of the cup. When the positioning body is located in the compressing position, it is secured at the positioning part of the lid so that the covered body can be pulled up, depressed, and positioned inside of the lid. The instant disclosure provides an operating method for the brewing cup instrument and its lid.

### CROSS-REFERENCE TO RELATED APPLICATION

This application is a U.S. national phase of International application No. PCT/CN2013/089008, filed on Dec. 10, 2013 which claims the benefits of priority of CN application No. 201210530659.9 filed on Dec. 10, 2012, the content of which are incorporated herein by reference.

### FIELD OF INVENTION

The instant disclosure relates to a brewing cup instrument; in particular, to a brewing cup instrument and lid with a compressible brewing substance packaging and its operating method.

### DESCRIPTION OF RELATED ART

The conventional brewing cup requires user to open the lid and separate the tea bag from the cup, in order to control the level of strength of the tea. How to place the wet tea bag and difficult to re-brew the tea bag are the problems of the conventional brewing cup. To compromise, many users choose to leave the tea bag in the cup, and have just one cup of strong tea, or throw away the tea bag after the first brewing, either way, it's inconvenient and waste of tea bag, because tea bag is supposed to be re-brewed.

To address the above issues, the inventor strives via associated experience and research to present the instant disclosure, which can effectively improve the limitations described above.

### SUMMARY OF THE INVENTION

The instant disclosure provides a brewing instrument, lid and its operating method for user to be able to easily control the compression of the tea bag and fasten the position of the tea bag without opening the lid.

The instant disclosure provides a brewing cup instrument, including: a cup, its inner section defines space of the cup; a lid, its inner section defines space of the lid, and a hole pass through the lid, and a positioning part at the outside edge of the lid. This lid functions as the cover of the cup, and the inner spaces of the cup and lid can be connected to the outside via the hole on the lid; a brewing substance packaging, it includes a rope body, a covered body, and a positioning body. The rope body can be moved through the hole of the lid, and one end of the rope body is fixed with the covered body, while the other end is fixed with positioning body. The positioning body is located at the outside of the lid, and can be adjusted between a brewing position and a compressing position. When the positioning body is located in the brewing position, it is driven by the gravity of the covered body, which is located at the other end of the rope body, and stopped by the lid, so that the covered body is hung inside of the cup. When the positioning body is located in the compressing position, it is secured at the positioning part of the lid so that the covered body can be pulled up and positioned inside of the lid.

Preferably, when the positioning body is in the compressing position, the covered body is driven by the force of the pulling the rope body, and compressed against the inner surface of the lid.

Preferably, the covered body includes a folded body which is a hollow object and capable of vertical compression. The cross-section of the folded body is ring shape and perpendicular to the stretching direction. The symmetrical folding lines are formed on the folded body. The covered body also includes a upper lid body and a lower lid body. Both lid bodies are coupled to two ends of the folded body and cover the openings respectively. A position hole in the center of the upper lid body allows the rope body to pass through the upper lid body and then secured at the bottom of the folded body. When the positioning body is adjusted between the brewing position and compressing position, the positions of the upper and lower lid bodies will be simultaneously adjusted and moved by the movement of the rope body, so that the folded body will be expanded or compressed.

The instant disclosure provides a lid for the brewing cup instrument as defined above.

The instant disclosure provides an operating method for the brewing cup instrument and its lid, such method includes the following steps: hanging step, pass the positioning body from inside of the lid through the hole of the lid, and place the positioning body on top of the outside surface, so that the covered body is hung under the lid; preparing step, fill the cup with the hot water; buckling step, put the lid on top of the cup and close it, so that covered body is located inside of the cup; brewing step, the covered body submerges as the result of the gravity and begins its brewing; compressing step, move the position body toward the position part located at outside edge of the lid, simultaneously, covered body will be pulled up and separate from the water. Repeat the steps for the next brewing.

In summary, the instant disclosure of the brewing cup instrument, lid, and its operating method enables user effortlessly operate the position body to separate the covered body from water without opening the lid, and compress the covered body so that the excess of water can be squeezed into the cup.

Furthermore, no more wet tea bag problem and the user can easily re-brew and control the level of tea strength he/she prefers.

### BRIEF DESCRIPTION OF THE DRAWINGS

FIG. 1 is a three-dimensional schematic diagram according to the present invention;

FIG. 2 is a cross-sectional schematic diagram of the positioning body located in the compressing position according to the present invention;

FIG. 3 is a cross-sectional schematic diagram of the positioning body located in the brewing position according to the present invention;

FIG. 4 is a three-dimensional schematic diagram of the positioning part formed on the annular side wall according to the present invention;

FIG. 5 is a cross-sectional schematic diagram of the positioning part being a notch according to the present invention;

FIG. 6 is a cross-sectional schematic diagram of the positioning body being in the passing mode according to the present invention;

FIG. 7 is a cross-sectional schematic diagram of the positioning body being an elastic body in the passing mode according to the present invention;

FIG. 8 is a cross-sectional schematic diagram of the positioning body being an elastic body in the stop mode according to the present invention;

FIG. 9 is a exploded schematic diagram of the brewing substance packaging structure according to the present invention;

FIG. 10 is a cross-sectional schematic diagram of the tea bag being in the spherical shape according to the present invention;

FIG. 11 is a three-dimensional schematic diagram of the rope body wound around the positioning part according to the present invention;

FIG. 12 is a three-dimensional schematic diagram of the positioning body longitudinally passed through and fixedly buckled to the positioning part according to the present invention;

FIG. 13 is a three-dimensional schematic diagram of the positioning body embedded into the positioning part according to the present invention;

FIG. 14 is a three-dimensional schematic diagram of the positioning body transversely passed through and fixed to the positioning part according to the present invention;

FIG. 15 is a cross-sectional schematic diagram of the tea bag without the limiting body according to the present invention; and

FIG. 16 is a schematic diagram of the tea bag being a three-dimensional triangle shape bag according to the present invention.

FIG. 17 is a schematic diagram of the tea bag being a general pocket shape bag according to the present invention.

FIG. 18 is a schematic diagram of the inner wall structure of the lid according to the present invention.

FIG. 19 is a schematic diagram of the step of the operating method according to the present invention (1).

FIG. 20 is a schematic diagram of the step of operating method according to the present invention (2).

FIG. 21 is a schematic diagram of the step of the operating method according to the present invention (3).

### DESCRIPTION OF THE KEY ELEMENTS

100 Brewing cup instrument
1 Cup
11 Cup space
2 Lid
21 Plate Body
211 Hole
212 Outlet
22 Side Wall
23 Lid space
24 Positioning part
241 Block
242 Groove
243 Notch
25 Retaining wall
3 Brewing substance packaging
31 Rope body
32 Position body
33 Covered body
331 Folded body
3311 Fold line unit
3312 Opening
3313 Opening
332 Upper cap
3321 Upper position hole
333 Bottom cap
3331 Lower position hole
334 Limiting body
C Stretching direction
200 Water

### DETAILED DESCRIPTION OF THE INVENTION

In order to further understand features and technical contents of the present invention, please refer to following detailed description and accompanying drawings according to the present invention. However, the drawings are only provided for reference and illustration, not for limiting the scope of the present invention.

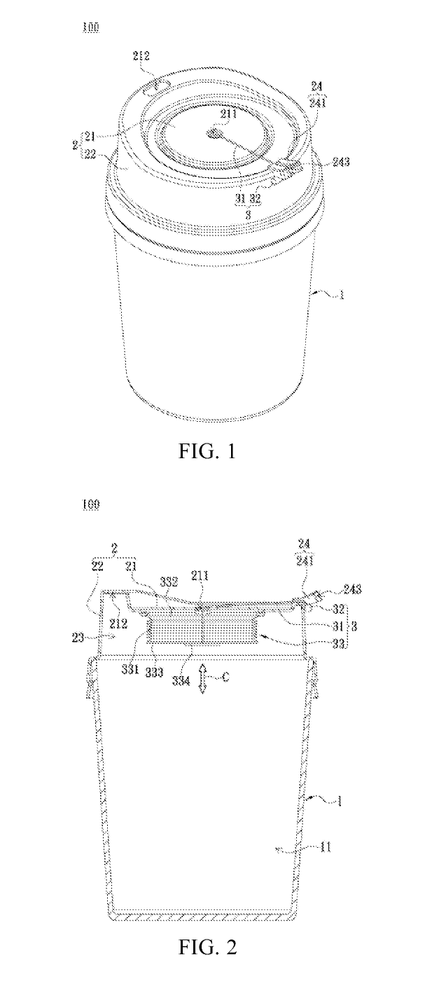

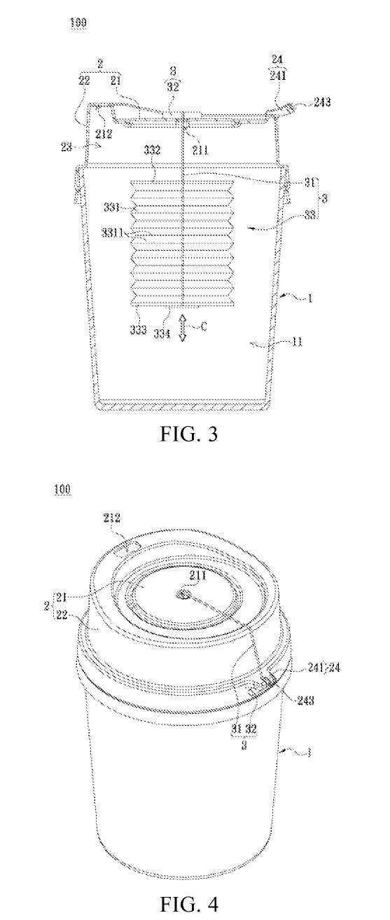

Please refer to FIG. 1˜FIG. 3, the embodiment provides a brewing cup instrument 100, which includes a cup 1, a lid 2, and a brewing substance packaging 3. The inner circle of the aforementioned cup 1 defines cup space 11 for the hot water. Cup 1 and lid 2 are perfectly fit for the closing, and the brewing substance packaging 3 is hung on the lid 2.

First, it should be noted that, since the brewing cup instrument 100 has various implementations, only part of implementations are illustrated as example in the embodiment, but not limited to.

The following mainly introduces preferred implementations of the brewing cup instrument 100. During the introduction, other possible implementations may be timely described; or, after introducing preferred implementations of the brewing cup instrument 100, related implementations of other brewing cup instruments 100 may be listed.

A plate body 21 is formed on the lid 2 and an annular side wall 22 is extended along the same side from a peripheral edge of the top wall 21, so that a lid space 23 surrounded by an inner edge of the lid 2 is defined.

Wherein, a hole 211 is set in approximately central portion of the top wall 21 of the lid 2. The above lid 2, an outlet 212 is formed on one side of the though hole 211 (left side as shown in FIG. 2), and a positioning part 24 is formed on another side of the though hole 211 (right side as shown in FIG. 2).

However, location of the hole 211 may be adjusted according to the design requirements, not limited to approximately central portion of the top wall 21. For example, the hole 211 may also be formed on the annular side wall 22.

In more detail, the positioning part 24 is a block 241 extended from the plate body 21 along the direction away from the hole 211, and a notch 243 is formed on an end edge of the block 241 along the direction towards the hole 211.

Furthermore, the inner edge of the bottom of the annular side wall 22 of the lid 2 is separately buckled on the cup body 1, so that the lid space 23 is connected with the cup body space 11 and connected with outside through the hole 211 and the outlet 212.

Besides, in addition to the above implement, the positioning part 24 also has other implementations. For example, as shown in FIG. 4, the positioning part 24 is a block 241 extended from annular side wall 22 along the direction away from the though hole 211, and a notch 243 is also formed concavely on the block 241.

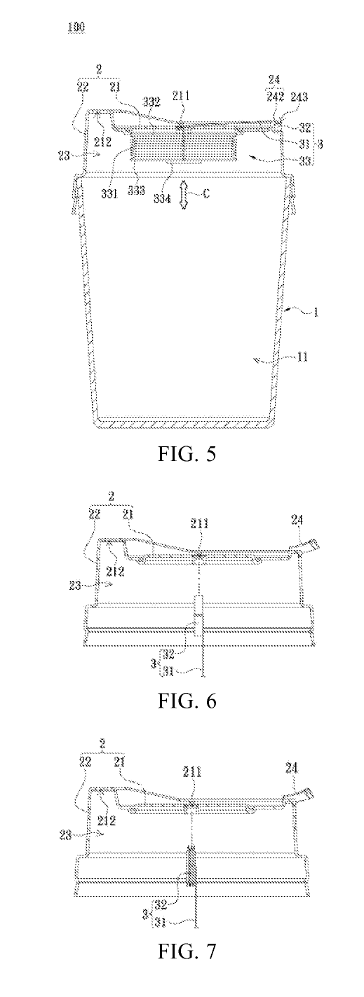

Or, as shown in FIG. 5, the positioning part 24 is a groove 242 concavely formed on the annular side wall 22, a notch 243 is concavely formed on the groove 242 near the though hole 211.

Please refer to FIG. 1˜FIG. 3, the brewing substance packaging 3 includes a rope body 31, a positioning body 32 and a covered body 33. The rope body 31 could be a cotton rope, a plastic rope or other material rope body.

Wherein, the rope body 31 is movably set inside the hole 211 of the lid 2, and two ends of the rope body 31 are respectively fixed to the positioning body 32 and the covered body 33. Whereby, the positioning body 32 is located on outer edge of the lid 2 and may be selectively adjusted to a brewing position (as shown in FIG. 3) and a compressing position (as shown in FIG. 2).

Thereinafter, structures of the positioning body 32 and the covered part 33 will be introduced respectively, and the conditions of the brewing cup set 100 related to the brewing position and the compressing position will be described later.

The positioning body 32 is a structure able to be switched to a passing mode (as shown in FIG. 6) and a stop mode (as shown in FIG. 2 or FIG. 3). Furthermore, when the positioning body 32 is at the passing mode, the positioning body 32 may be passed through the hole 211 from one side of the lid 2 (inner side) to another side of the lid 2 (outer side); when the positioning body 32 is at the stop mode, the positioning body 32 is set and positioned on one side of the hole 211 of the lid 2 (outer side).

In more detail, as shown in FIG. 6, the positioning body 32 is a long-shaped rod body, which may be cylindrical shape, elliptic cylindrical shape, square pillar shape, diamond shape or long flat shape. The length of the rod body is larger than the inside diameter of the hole 211, a section of the positioning body 32 vertical to its long axis direction is provided to pass through the hole 211 on the top wall 21 of the lid 2.

That is, the passing mode is defined as the positioning body 32 passing through the hole 211 along its long axis direction (as shown in FIG. 6), and the stop mode is defined as the positioning 32 not passing through the hole 211 along the long axis direction (as shown in FIG. 2 or FIG. 3). Therefore, the positioning body 32 may be passing through the hole 211 from the inner side of the top wall 21 of the lid 2 at the passing mode, and may be setting on outer side of the top wall 21 of the lid 2 at the stop mode.

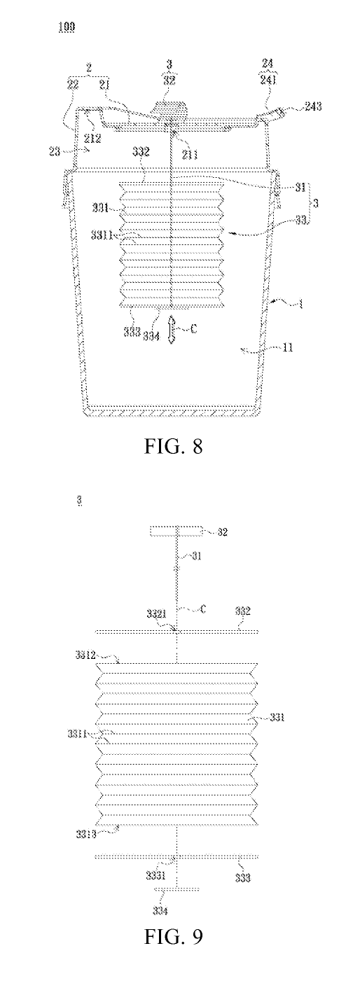

Besides, in addition to the above implement, the positioning body 32 also has other implementations. For example, as shown in FIG. 7 and FIG. 8, the positioning body 32 may be an elastic body (such as creased paper with elastic resilience as shown in figure), because an elastic body is suitable for been compressed (or through folding and rolling) into a structure for being passed through the hole 211, it is defined as the passing mode; the elastic body recovers its original appearance and structure after passing through the hole 211, at this time, the elastic body cannot be passed through the hole 211, it is defined as the stop mode. Furthermore, the elastic body may also be elastic material that deforms under extrusion and recovers without extrusion.

Or, the positioning body 32 may also be an umbrella-shaped structure (not shown in figure), that is, when the umbrella-shaped structure is close, it is the structure that may be passed through the hole 211, so it is defined as the passing mode at the time; when the umbrella-shaped structure is opened, the opened curved umbrella surface cannot be passed through the though hole 211, so the umbrella-shaped structure is defined as the stop mode.

Please refer to FIG. 9, the covered body 33 includes a folded body 331, an upper lid body 332, a lower lid body 333 and a limiting body 334. Wherein, in the embodiment, the preferred implementation of the brewing substance inside the covered body 33 is full tea leaves, but it is not limited in practical application. For example, it may be herbs (such as cordyceps), coffee beans (especially not instant), herb tea, or fruit tea etc.

Furthermore, the folded body 331, the upper lid body 332, the lower lid body 333 and the limiting body 334 are independent elements, the covered body 33 is formed by assembling such elements. In the following, the structure of the folded body 331, the upper lid body 332, the lower lid body 333 and the limiting body 334 will be introduced respectively with reference to FIG. 9.

The folded body 331 is generally in hollow cylindrical shape, and a stretching direction C is defined in the inner side, the stretching direction C is equivalent to the central axis direction of the folded body 331 in the embodiment, but not limited to.

Furthermore, the section of the folded body 331 vertical to the stretching direction C is ring shape, a fold line unit 3311 approximately symmetrical to the stretching direction C is formed on the folded body 331, and two openings 3312, 3313 are formed respectively on two relative ends of the folded body 331.

In more detail, the fold line unit 3311 includes multiple alternated arranged inner fold lines and outer fold lines with shape substantially the same. In other words, each outer fold line is located between two adjacent inner fold lines. Through the fold line unit 3311, two ends of the folded body 331 may be stretched or compressed along the stretching direction C.

The structures of the upper lid body 332 and the lower lid body 333 are approximately the same, further, the upper lid body 332 and the lower lid body 333 are both circular plate shape and two positioning holes 3321, 3331 are respectively formed in their geometric center. In other words, the location of the center of the two positioning holes 3321, 3331 is approximately located in the stretching direction C (or the central axis of the folded body 331).

Wherein, compared to the folded body 331, the shape of the upper lid body 332 and the lower lid body 333 is not easy to deform. Specifically, the thickness (or density, hardness) of the upper lid body 332 and the lower lid body 333 are designed as larger than that of the folded body 331, so that the shape of the upper lid body 332 and the lower lid body 333 is not easy to deform.

The limiting body 334 is a structure which cannot be passed through the positioning hole 3331 of the lower lid body 333, for example, the limiting body 334 may be a tabular structure with area larger than the positioning hole 3331, or a long-shaped structure (such as similar to the positioning body 32) with length larger than the diameter of the positioning hole 3331.

As above, the structures of the folded body 331, the upper lid body 332, the lower lid body 333 and the limiting body 334 are illustrated. Now the assembly relationship among the folded body 331, the upper lid body 332, the lower lid body 333 and the limiting body 334 will be illustrated.

Please refer to FIG. 3 and FIG. 9, the upper lid body 332 and the lower lid body 333 are respectively connected to the two relative ends of the folded body 331 (such as the top and the bottom of the folded body 331 shown in FIG. 9), to thereby cover the two openings 3312, 3313 formed by the folded body 331.

Wherein, the method of connecting the upper lid body 332 and the lower lid body 333 to two relative ends of the folded body 331 may be bonded with food-grade waterproof glue, welded in ultrasonic welding way, or other suitable method, which is not limited herein.

The rope body 31 is passed through the positioning hole 3321 of the upper lid body 332, passed through the positioning hole 3331 of the lower lid body 333, and may be fixed to the limiting body 334. It is not limited whether the limiting body 334 is connected to the lower lid body 333.

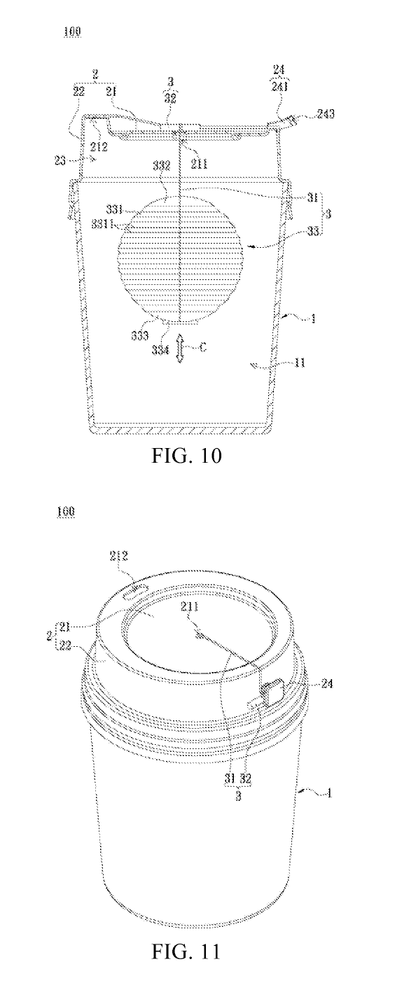

Besides, in addition to the above implementation, the covered body 33 may also have other implementations. For example, as shown in FIG. 10, the shape of the covered body 33 is designed as spherical shape, and presents a different style and fun. The shape of the covered body 33 may also be designed as hemispherical shape, cone shape, pillar shape, or other imaginable shape.

The structures of the positioning body 32 and the covered body 33 were described as above, and the actual operation and use of the brewing cup instrument 100, referring to FIG. 2 and FIG. 3, may be described as following.

It should be noted that to brew the covered part 33, user first pours hot water inside the cup body space 11 of the cup body 1 and closes the lid 2 on the cup body 1, so that the covered part 33 hung on the lid 2 is placed inside the space surrounded by the lid 2 and the cup body 1.

In more detail, when the positioning body 32 is adjusted to the brewing position, it is driven by the gravity of the covered part 33, so that it moves toward the top wall 21 of the lid 2, and stops at hole 211 on the outer edge, in other words, the positioning body 32 is located on the outer edge of the top wall 21 of the lid 2, so that the covered part 33 is located in the cup body space 11, submerging into hot water inside the cup body 1.

At this moment, hot water flows evenly into the folded body 331, it is the perfect brewing condition for the brewing substance (such as full tea leaves), and the stretching direction C is parallel to the plumb-line direction.

Thereafter, during brewing, the brewing substance may be soaking and expanded to the upper lid body 332 and the lower lid body 333, so that the folded body 331 may stretch up and down naturally along the stretching direction C. Consequently, the brewing substance may have adequate space for further brewing and stretching.

Furthermore, due to moderate strengthen of the upper lid body 332 and the lower lid body 333 (such as improvement of thickness, density, or hardness), the folded body 331 may maintain its original shape even when it is completely submerged in water, namely, it would be able to carry the weight of the brewing substance and not deform.

In addition, by moderate strengthening the upper lid body 332 and the lower lid body 333, when the folded body 331 is submerging, it would not float in any direction other than sinking down, due to the weight shift caused by the submerging angle and water flow, so that the folded body 331 may surface partially and the brewing substance inside the covered part 33 may not completely be brewed. And, the folded body 331 would not sag and deform due to the increasing weight of the brewing substance after brewing and stretching and would not cause any difficulty to compress.

After the covered part 33 in the cup body 1 being brewed to the desired degree of strength, the positioning body 32 may be switched to the compressing position, at this stage, the positioning body 32 is secured at the positioning part 24 of the lid 2, so as to the covered part 33 at least partially located inside the lid space 23, thereby achieve the effect of separating the covered part 33 from the water.

In more detail, the rope body 31 may be passed through the notch 243 of the positioning part 24, thus the positioning body 32 may be positioned on one side away from the hole 211, so as to the positioning body 32 will be driven by gravity of the covered part 33 and secured at the surface of two relative sides of the notch 243 located at the positioning part 24.

In the process of adjusting the positioning body 32 from the brewing position to the compressing position, the rope body 31 may pull the limiting body 334, so that the covered part 33 may move up toward the top wall 21 of the lid 2 (namely, it is equivalent to parallel to the plumb-line direction). When the upper lid body 332 of the covered part 33 reaches and stops at the inner edge of the top wall 21 of the lid 2, the limiting body 334 is pulled by the rope body 31 and the lower lid body 333 starts to move toward the upper lid body 332, and the fold line unit 3311 of the folded body 331 is folding along the stretching direction C. That is, the volume and height of the covered part 33 is smaller when the positioning body 32 located at the compressing position, and larger while the positioning body 32 located at the brewing position.

In particular, when the positioning body 32 is adjusted from the brewing position to the compressing position, the sum of the moving distance of the top of the covered part 33 (equivalent to the upper lid body 332) and the relative moving distance of the bottom of the covered part 33 (equivalent to the lower lid body 333) and the covered part 33 (equivalent to the upper lid body 332) is approximately equal to the length of the rope body 31 from the hole 211 to the positioning body 32 secured at the positioning part 24.

Additionally, when the folded body 331 is folding from two ends along the stretching direction C, the upper lid body 332 and the lower lid body 333 may provide some protection function so that the brewing substance of the covered part 33 would not be crushed during the compression.

In addition to above embodiments (through gravity), the methods for the positioning body 32 securing at the positioning part 24 may also include other variety. For example, shown in FIG. 11, the positioning part 24 is extended from the annular side wall 22 of the lid 2 and formed approximately a T-shaped structure, so that the rope body 31 may be wound around the positioning part 24, and the positioning body 32 is annexed to the positioning part 24, thereby maintain the positioning body 32 at the compressing position.

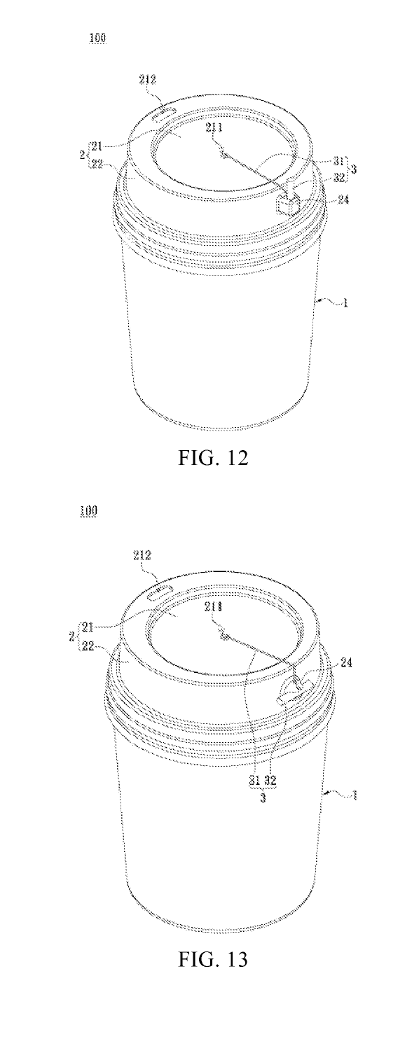

Or, as shown in FIG. 12, the positioning part 24 may be a top-down concave structure, and the positioning body 32 longitudinally passed through and fixed to the positioning part 24, thereby maintain the positioning body 32 at the compressing position.

Furthermore, the buckling structure of securing the positioning body 32 to the positioning part 24 is not limited to FIG. 12, the buckling method may also has other variation that cannot be listed herein.

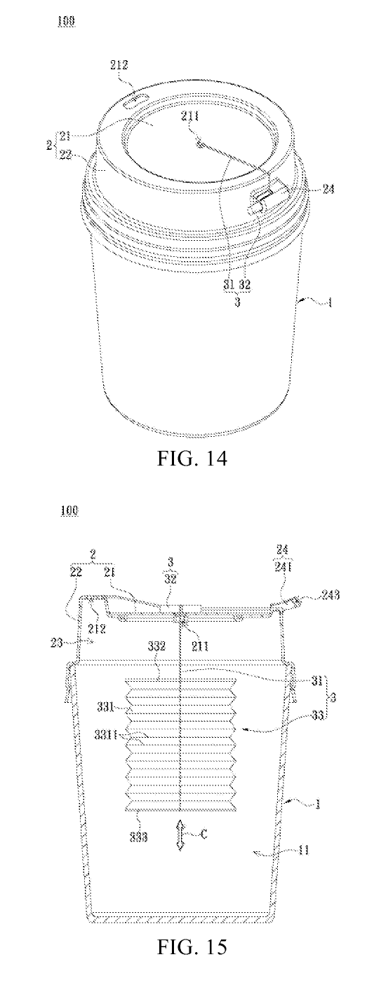

Case in point, two figures are showed here as examples. In FIG. 13, the structure of the positioning part 24 is designed for embedding the positioning body 32 inside. In FIG. 14, the structure of the positioning part 24 is designed for the positioning body 32 transversely passed through and fixed inside.

Furthermore, in addition to the above implementation of the embodiment, the covered part 33 may also have other variations. For example, as shown in FIG. 15, the limiting body 334 is absent from the covered part 33, the bottom end of the rope body 31 may be directly fixed to the lower lid body 333. Or, the rope body 31 may be tied after being passed through the positioning hole 3331 of the lower lid body 333, and the tied portion of the rope body 31 may not be passed through the positioning hole 3331 of the lower lid body 333.

Or, the upper lid body (figure not shown) may be omitted so that one end of the rope body 31 is placed inside the covered part 33 and fixed to the bottom of the covered part 33. But, no matter how the covered part 33 varies, when the positioning body 32 is located in the compressing position, the covered part 33 shall be pulled by the rope body 31 and press against the inner edge of the top wall 21 of the lid 2 to form a compression shape.

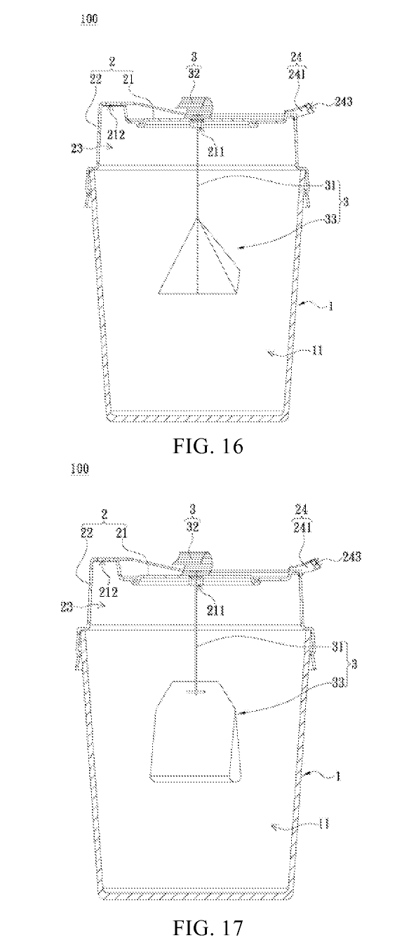

Also, the covered part 33 may be a cylindrical bag, a oval cylindrical bag, a square cylinder bag, a three-dimensional triangular shape (as shown in FIG. 16), or a flat bag. Although the covered part 33 may not always include the upper lid body 332 and the lower lid body 333 simultaneously, the rope body 31 may be passed through the covered part 33 and fixed to its bottom, the covered part 33 may be pulled up when the rope body 31 is pulled from one end, the covered part is equally pressed by the bottom of the covered part 33 and the top wall 21 of the lid 2, so that the volume or height of the covered part 33 is smaller when the positioning body 32 is located in the brewing position, and larger in the compressing position.

In other words, the covered part 33 may move toward the inner plate body 21 of the cup 2 by the pulling movement of the rope body 31, so as to the distance between two sides of the covered part 33 corresponding to the rope body 31 (equals to the height of the covered part 33), is smaller when the positioning body 32 is in the compressing position than in the brewing position. Namely, the height of the covered part 33 is smaller when the positioning body 32 is in the compressing position than in the brewing position.

Furthermore, as indicated in FIG. 17, the covered body may be an ordinary flat bag, and the rope body 31 is fixed at the top of the flat bag. The flat bag may move up and down, with the movement of the position body 32 in the compressing or brewing position. Also, the covered body may be a ordinary triangle bag. However, either flat or triangle bag may not able to compress.

In addition, in the embodiment, only one positioning part 24 of the lid 2 is illustrated, but in practical application, more than one positioning part 24 may be placed between the brewing position and the compressing position, to thereby suitable for different conditions when the cup body 1 containing different amount of water.

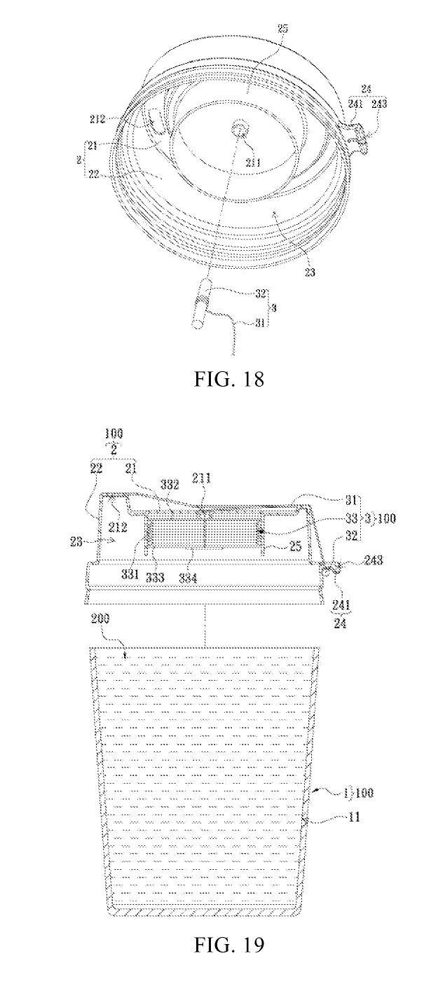

In addition to above embodiments, the inner wall of the plate body 21 of the cup 2 may be extended to form a retaining wall 25, a annular shape section (as shown in FIG. 18). Retaining wall 25 may be located in the cup space 23. Furthermore, the space surrounded by the retaining wall 25 (or the height of the retaining wall 25) may be approximately related to the height of the covered body 33 in compressing state, so as to when the position body 33 is in the compressing position, most part of the covered body 32 (preferably the whole covered body 32) is situated inside the space surrounded by the retaining wall 25. The retaining wall 25 may limit the movement of the covered body 33 when in compressing state, and avoid the liquid flowing pass the covered body 33 when the user drinks it.

So far, the detailed structure of the brewing cup instrument 100 is illustrated, now the operating method will be introduced. The following illustrations will be based upon the structure of cup 2 in FIG. 18. Nevertheless, the practical applications of the brewing cup instrument 100 may vary, depending upon the variations, and not limited to FIG. 18.

Please refer to FIG. 18 to FIG. 21, which are the schematic diagrams of the step of the operating method. Please be advised that the operating steps illustrated later not necessarily define the order of the operating steps, such as the preparation step may be performed before the hanging step. The operating method of the brewing cup instrument 100 includes the following steps:

Perform—hanging step, referring to FIG. 18 and FIG. 19, passing the position body 32 of the brewing substance packaging 3 through the hole 211, located in the inner space of lid 2. The brewing substance packing 3 is hung inside of lid 2, because the position body 32 is secured at the outside surface of the lid 2.

The preferable position for the position body 32 is at the position part 24, by pulling the rope body 31 passing the notch 243 and by the gravity of the covered body 33, the position body 32 is secured at the surfaces of the notch 243. Because now the covered body 33 is fixed at the lid 2, user is able to easily perform the other steps.

Perform—preparing step, referring to FIG. 19, fill water 200 into the cup space 100 of the cup 1. The temperature of the water 200 varies and depends upon the type of the brewing substance and the user's preference, not limited to 100 degree centigrade or other degrees. In other words, the water 200 in the instant disclosure may be hot water, room temperature water or cold water.

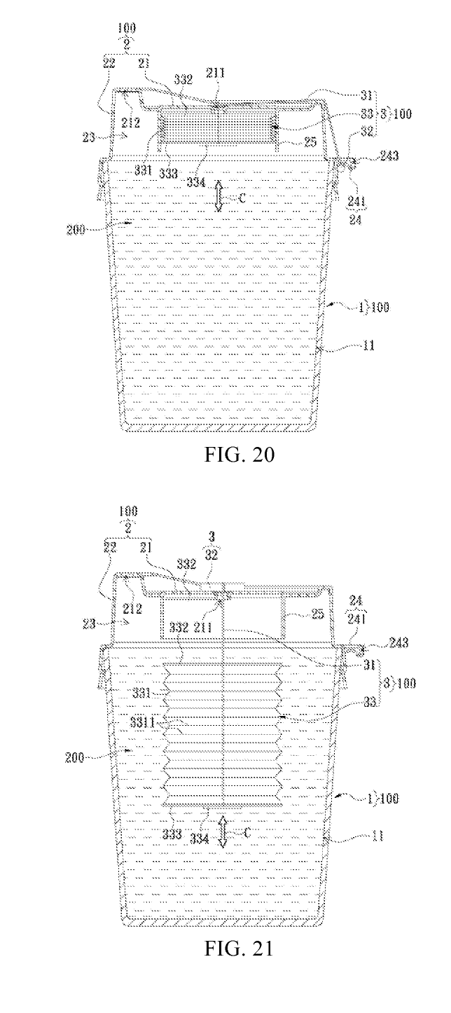

Perform—buckling step, referring to FIG. 19 and FIG. 20, close the lid 2 on the cup 1, so that the covered body 33 is located inside lid space 23 and cup space 11.

Perform—brewing step, referring FIG. 20 and FIG. 21, remove the position body 32 from the position part 24, so that the position body 32 is located at the hole 211 of the outside cover of the lid 2. The covered body 33 will submerge into the water 200 contained in the cup 1, as the gravity movement, and begin the brewing step. The water 200 is a general term and is not limited to the tea, it may be the herb drink (such as cordyceps), coffee (especially not instant), herb tea, or fruit tea etc.

Perform—compressing step, referring to FIG. 21 and FIG. 20, this step is similar to the hanging step, except that when in compressing step, the cup 1 and lid 2 are in the closing mode

The details of the compressing step are: move the position body 32 of the brewing substance packaging 3 toward the position part 24 of the lid 2, passing the rope body 31 through the notch 243, and locate the position body 32 at the position part 24 far away from the hole 211. The position body 32 is secured at position part 24 as the gravity movement of the covered part 33 pulling it against the both surfaces of the notch 243.

Meanwhile, the above stated movement will pull the covered part 33 up, so that the upper lid body 332 of the covered body 33 touches the inner space of the lid 2, while the rope body 31 continues pulling the lower lid body 333 up. The folded body 331 is compressing along the stretching direction C, because of the pressure from the lid 2 and lower lid body 333, resulting the covered part 33 in compressed shape and located inside of the lid space 23, and separating from the water 200.

Perform—tasting step, user drinks water 200 from the outlet 212. In case that the water 200 is not reaching the desired degree of strength, user may repeat the brewing, compressing, and tasting steps until the water 200 reaches the desired strength. As the level of strength varies for each user, when the water 200 is too strong, the user can open the lid 2 and pour water into the cup 1 to dilute the water 200.

When the user finishes the water 200, he/she opens the lid 2 (separating the lid 2 and cup 1), and repeats the next operating method, that is, preparing, buckling, brewing, compressing, and tasting steps.

### Possible Effects of the Embodiment

In summary, the advantages of the brewing cup instrument and lid and its operating method are:

1. easy to separate the covered body from the drink. The user can effortlessly operate the position body to move the covered body (such as a tea bag) up and down, without opening the lid. No more dripping tea bag and how to place a wet tea bag problems.

2. easy to multiple brewing. It is known that tea leaves release the best flavors after the first brewing. The user can rebrew the covered body effortlessly and enjoy his/her drink multiple times. No more tea bag waste problem.

3. easy to control level of strength of the covered body. The user can enjoy his/her desired level of strength of tea with a simple operation. No more strong or bitter tea problem.

4. compressible covered body. When in brewing stage, the covered body is expanded and provides an ample space for steeping, while in the stage of compressing, the volume and height of the covered body are reduced so that it's easy for the user to drink, re-brew or clean up.

1. A brewing cup instrument, including:
a cup, its inner section defines space of the cup;
a lid, its inner section defines space of the lid, and a hole pass through the lid, and a positioning part at the outside edge of the lid, the lid functions as the cover of the cup, and the inner spaces of the cup and lid can be connected to the outside via the hole on the lid; and
a brewing substance packaging, it including a rope body, a positioning body, and a covered body, wherein the rope body can be moved through the hole of the lid, and one end of the rope body is fixed with the covered body, while the other end is fixed with positioning body, the positioning body is located at the outside of the lid, and can be adjusted between a brewing position and a compressing position;
when the positioning body is located in the brewing position, it is driven by the gravity of the covered body, which is located at the other end of the rope body, and stopped by the lid, so that the covered body is hung inside of the cup, when the positioning body is located in the compressing position, it is secured at the positioning part of the lid so that the covered body can be pulled up and positioned inside of the lid,
wherein the covered body includes;
a folded body which is a hollow object and capable of vertical compression, and the cross-section of the folded body is ring shape and perpendicular to the stretching direction, and the symmetrical folding lines are formed on the folded body; and
a upper lid body and a lower lid body, both lid bodies are coupled to two ends of the folded body and cover the openings respectively, and a position hole in the center of the upper lid body allows the rope body to pass through the upper lid body and then secured at the bottom of the folded body, when the positioning body is adjusted between the brewing position and compressing position, the positions of the upper and lower lid bodies will be simultaneously adjusted and moved by the movement of the rope body, so that the folded body will be expanded or compressed.

2. The brewing cup instrument according to claim 1, wherein the positioning body is a structure able to be switched to a passing mode or a stop mode, when the positioning body is at the passing mode, the positioning body may be passed through the hole from one side of the lid (inner side) to another side of the lid, and when the positioning body is at the stop mode, the positioning body is set and positioned on one side of the hole of the lid (outer side).

3. The brewing cup instrument according to claim 2, wherein the positioning body is a long-shaped rod body, the length of the rod body is larger than the inside diameter of the hole, when a section of the positioning body vertical to its long axis direction passing through the hole on of the lid, it is defined as the passing mode, and the stop mode is defined as the positioning body not passing through the hole, the positioning body therefore may be passing through the hole from the inner side of the lid at the passing mode, and may be setting on outer side of the lid at the stop mode.

4. The brewing cup instrument according to claim 3, wherein the position part is a block structure with a notch, when the position body is in the compressing position, the rope body will pass the notch, and the position body will be secured at the surface of the notch because of the gravity movement of the covered body.

5. The brewing cup instrument according to claim 1, wherein the inner wall of the plate body of the cup is extended to form a retaining wall, a annular shape section, when the position body is in the compressing position, most part of the covered body is situated inside the space surrounded by the retaining wall.

6. The brewing cup instrument according to claim 1, wherein the rope body passing from the upper end of the folded body and fixed at the bottom of the folded body, when the position body is in the compressing position, the covered body is moved up by the movement of the rope body, and pressed against the inner part of the lid, finally the covered body is fully compressed.

7. (canceled)

8. The brewing cup instrument according to claim 6, wherein the folded body includes a limiting body which structure is constructed so that the rope body after passing through the position hole of the lower lid body is fixed at the limiting body, the positioning holes of the upper lid body and lower lid body are located at the geometric center of each lid body.

9. (canceled)

10. An operating method for the brewing cup instrument according to claim 1, wherein the operating method includes the following steps:
perform—hanging step, passing the position body of the brewing substance packaging through the hole, located in the inner space of lid, the brewing substance packing is hung inside of lid, because the position body is secured at the outside surface of the lid;
perform—preparing step,
Perform—buckling step, closing the lid on the cup filled with water, so that the covered body is located inside lid space and cup space;
perform—brewing step, moving the position body to the hole of the outside cover of the lid, so that the covered body will submerge into the water contained in the cup, as the gravity movement, and begin the brewing step; and
perform—compressing step, moving the position body of the brewing substance packaging toward the position part of the lid, and secured at position part, meanwhile, the covered part will be pulled up and compressed and separating from the water;
when finishing the water, the user opens the lid and repeats the next operating method, that is, preparing, buckling, brewing, compressing, and tasting steps.

11. The brewing cup instrument according to claim 2, wherein the rope body passing from the upper end of the folded body and fixed at the bottom of the folded body, when the position body is in the compressing position, the covered body is moved up by the movement of the rope body, and pressed against the inner part of the lid, finally the covered body is fully compressed.

12. The brewing cup instrument according to claim 3, wherein the rope body passing from the upper end of the folded body and fixed at the bottom of the folded body, when the position body is in the compressing position, the covered body is moved up by the movement of the rope body, and pressed against the inner part of the lid, finally the covered body is fully compressed.

13. The brewing cup instrument according to claim 4, wherein the rope body passing from the upper end of the folded body and fixed at the bottom of the folded body, when the position body is in the compressing position, the covered body is moved up by the movement of the rope body, and pressed against the inner part of the lid, finally the covered body is fully compressed.

14. The brewing cup instrument according to claim 5, wherein the rope body passing from the upper end of the folded body and fixed at the bottom of the folded body, when the position body is in the compressing position, the covered body is moved up by the movement of the rope body, and pressed against the inner part of the lid, finally the covered body is fully compressed.

15. The brewing cup instrument according to claim 11, wherein the folded body includes a limiting body which structure is constructed so that the rope body after passing through the position hole of the lower lid body is fixed at the limiting body, the positioning holes of the upper lid body and lower lid body are located at the geometric center of each lid body.

16. The brewing cup instrument according to claim 12, wherein the folded body includes a limiting body which structure is constructed so that the rope body after passing through the position hole of the lower lid body is fixed at the limiting body, the positioning holes of the upper lid body and lower lid body are located at the geometric center of each lid body.

17. The brewing cup instrument according to claim 13, wherein the folded body includes a limiting body which structure is constructed so that the rope body after passing through the position hole of the lower lid body is fixed at the limiting body, the positioning holes of the upper lid body and lower lid body are located at the geometric center of each lid body.

18. The brewing cup instrument according to claim 14, wherein the folded body includes a limiting body which structure is constructed so that the rope body after passing through the position hole of the lower lid body is fixed at the limiting body, the positioning holes of the upper lid body and lower lid body are located at the geometric center of each lid body.
